(19) United States
(12) Patent Application Publication
(10) Pub. No.: US 2011/0296175 A1
(43) Pub. Date: Dec. 1, 2011

(54) SYSTEMS AND METHODS FOR SOFTWARE LICENSE DISTRIBUTION USING ASYMMETRIC KEY CRYPTOGRAPHY

(75) Inventor: Jangwoo Shin, Iansdale, PA (US)

(73) Assignee: beonSoft Inc., Fort Washington, PA (US)

(21) Appl. No.: 12/881,312

(22) Filed: Sep. 14, 2010

Related U.S. Application Data
(60) Provisional application No. 61/347,825, filed on May 25, 2010.

(51) Int. Cl. H04L 9/08; H04L 9/00; H04L 9/32

(52) U.S. Cl. 713/164; 713/176; 380/44; 380/278

(57) ABSTRACT

Methods and computer readable media for distributing a software license based on asymmetric cryptography via a network. An application publisher generates an asymmetric key-pair having an encryption key and a decryption key. The publisher assembles a software application embedded with the decryption key and releases the software application on an application storefront while keeping the encryption key as secret. A user of a device downloads the software application via a public network. To activate the software application in the device, the user sends a request for a license key to the publisher (or a distribution service provider) via the network. Upon validation of the request, the license key encrypted using the encryption key is sent to the device to thereby activate the software application in the device. Based on the cryptographic technique, the user may surrender the license key to get back the credit for the surrendered license key.

### CROSS REFERENCE TO RELATED APPLICATIONS

This application claims the benefit of U.S. Provisional Application No. 61,347,825, entitled “Method and system for software license distribution using asymmetric key cryptography,” filed on May 25, 2010, which is hereby incorporated herein by reference in its entirety.

### BACKGROUND OF THE INVENTION

The present invention relates to software licensing systems using asymmetric cryptography.

An existing approach for software licensing is to create a custom-made software package for a specific deployment environment instead of creating mass-distribution packages as disclosed in U.S. Pat. No. 6,134,659. This approach can warrant security against software piracy as long as the host environment can be uniquely identified in advance, and can be used as part of license authorization for enforcing software license. However, for this specific reason, the practice is generally not applicable for mass-production and distribution of software for generic computing devices in a large scale.

A traditional method of software licensing for general purpose personal computing devices (PCs) was developing copy protection technologies to prevent application programs from being duplicated to other writable media, such as magnetic floppies or optical CDs as disclosed in U.S. Pat. Nos. 4,975,898 and 5,809,006. The intellectual properties under protection are to be distributed over those types of media and are therefore susceptible to piracy, which in most cases is meant to produce illegal copies of the original media and to install said copies at other compatible execution devices. This method became less popular because such licensing technology made it harder to produce and distribute software in a large scale without incurring additional cost and also posed inconvenience to legal users in terms of requiring specially designed apparatuses or causing incompatibility issues with other devices. This approach also became technologically less dependable as advanced hardware and software were made available at affordable prices, which can neutralize most anti-piracy apparatus designed and implemented for protection of intellectual property contained in recordable media.

Another commonly used and still popular approach is to distribute deactivated software contained in generic media such as CDs or DVDs, and enforce copyright protections by requiring user to enter secret activation keys, CD keys, hidden in the packaging material. However, the stealing or sharing of such ‘activation key’ among users neutralizes the protection instantly. Many variations of this technique became widely available. For example, a prior art U.S. Pat. No. 6,873,717 mandates users to execute a registration process within certain time frame for individual user authentication and tracking of the use of products. Nevertheless, the registered code can still be leaked and illegally used by other users. Other approaches, as disclosed in U.S. Pat. Nos. 5,652,793 and 6,769,064, utilize additional hardware devices supporting license enforcement. However, in such cases, such additional device increases production cost and limits mass-production-consumption of software product under protection of such devices.

Another type of licensing scheme is to validate dynamically generated passwords and/or license codes customized for a host computer where software product is deployed. Most prior arts related to this technology work similarly—software is released containing either a series of valid password or a programmable logic of password validation algorithms. Software manufacturers or marketers issue a valid password following a required registration process and require subsequent renewal of subscription for a continued usage of the software. For additional security for reducing abuse and piracy, the validation process may utilize certain combinations of (i) unique hardware information where software is to be installed, (ii) a part of registration information, or (iii) the serial number issued to each software package, as part of the password validation process. For example, a prior art U.S. Pat. No. 6,986,063 discloses a version of such schemes where an encrypted password (activation code) is generated and delivered while mandating users to periodically authenticate the subscription status by installing those remotely generated passwords. The passwords are digitally signed using hardware information of the registrant so that it can only be decrypted and validated at the authorized hardware environment. A drawback of all known dynamic password validation is that it increases the burden of the password administrator in two critical ways: 1) the security of the licensing scheme depends on the secrecy of the password validation process employed (or static series of valid passwords per each software serial number) to prevent anyone from generating arbitrary valid keys, and 2) the number of encryption keys (to generate digital certificate for each software deployment) under management increases as the number of deployment increases, meaning that a licensor should take responsibility to securely collect, generate and manage one encryption key per each deployment.

FIG. 1 shows how a conventional public key cryptography, a.k.a. asymmetric cryptography, is used to establish a shared secret between two end-points, Alice and Bob, over an insecure network 110. As depicted, Alice uses a key generation process 102 to create a cryptographically secure key-pair: a decryption key 103a and an encryption key 103b. Then, the owner of the key, Alice, releases the encryption key to the public including Bob, while securely guarding the secrecy of the decryption key 103a. Using the encryption key 103b received from Alice, Bob uses a cryptography Application Programming Interface (API) 102 to encrypt a plain text 120 to thereby generate a secure message 122. This encrypted message 122 is then forwarded to the receiver (the key owner) via the insecure network (such as the Internet) 110. Then, using the decryption key 103a that remains as secret to the receiver, a cryptography API 112 of the receiver decrypts the encrypted message 122, to thereby restore the original plain text message 120. By decrypting the message, Alice can detect 1) authenticity of encryption key 103b and 2) alteration attacks of the message 120 happened in the insecure network 110.

Alice may send a plain text message 126 to Bob with a digital signature 128. The cryptography API 112 authenticates, using the private key 103a, a digital signature 128 of the message 126 and attaches the authenticated digital signature to the plain text message 126. When Bob receives the package having the message 126 and the digital signature 128, the cryptography API 102 checks the authenticated digital signature 128, using the public key, to thereby determine the identity of the sender and the alteration attacks of the message. A key feature of public key cryptography is in irrefutable ‘digital signature of message digest’—once a known message is signed using the private key 103a, anyone having access to the public key 103b can authenticate if the message is really signed (thus irrefutable) by the signer. If the sender identity is not acceptable or the message 126 was attacked, Bob may reject the message 126.

The security of the asymmetric cryptography depends not on the secrecy of the encryption-decryption process, but rather the mathematical complexity of the so called trap-door function, which makes it extremely hard to 1) guess the decryption key given encryption (public) key and multiple samples of cipher text and matching plain text, and 2) decrypt a cipher text correctly without the knowledge of the decryption key.

Numerous systems have been proposed as a software distribution and license management platform including some of the prior art patents discussed above. Almost all of them incorporate some types of encryption schema to prevent piracy and warrant secrecy of software license. Further examples include approaches disclosed in U.S. Pat. Nos. 5,142,578 and 6,260,141. However, the existing approaches suffer exponential increase in the number of secrets to manage, thus undermining usability of such license managing schema in practice in a large scale, because the number of secrets in all disclosed prior arts is a function of some combinations of 1) the number of licenses issued, 2) the number of deployment hosts, and 3) the number of applications released. Thus, there is a need for a cryptography that reduces the burdens of key/password management task and software serial number tracking for a large number of applications and deployment hosts without compromising the level of security.

### SUMMARY OF THE INVENTION

In one embodiment of the present disclosure, a method and computer readable media are provided for distributing a software license based on asymmetric cryptography via a network. The method includes: preparing a software application assembled with a decryption key; receiving a request for a license key from a device via a network, wherein the device includes the software application and the license key is adapted to activate the software application; and sending the license key encrypted using an encryption key to the device to thereby activate the software application in the device, the encryption key and the decryption key forming an asymmetric key pair.

In another embodiment of the present disclosure, a method and computer readable media are provided for distributing a software license based on asymmetric cryptography via a network. The method includes: generating an asymmetric key pair having an encryption key and a decryption key; assembling a software application embedded with the decryption key; causing a device to install the software application therein; sending, via the network, a license key encrypted using the encryption key to the device to thereby activate the software application.

These and other features, aspects and advantages of the present invention will become better understood with reference to the following drawings, description and claims.

### BRIEF DESCRIPTION OF THE DRAWINGS

FIG. 1 shows how a conventional public key cryptography, a.k.a. asymmetric cryptography, is used to establish a shared secret between two end-points over an insecure network;

FIG. 2 shows a software licensing system using asymmetric cryptography in accordance with one embodiment of the present invention;

FIG. 3 shows a flow chart illustrating exemplary steps that might be carried out to register the user device of FIG. 2;

FIG. 4 shows a flow chart illustrating exemplary steps that might be carried out by the publisher in FIG. 2 to generate a software application embedded with a decoding key;

FIG. 5 shows a flow chart illustrating exemplary steps that might be carried out to activate a software application in the user device of FIG. 2;

FIG. 6 shows a flow chart illustrating exemplary steps that might be carried out to deactivate a software application in the user device of FIG. 2;

FIG. 7 illustrates a typical computer system that may be employed in accordance with the present invention; and

FIG. 8 shows a user device (end user) in accordance with another embodiment of the present invention.

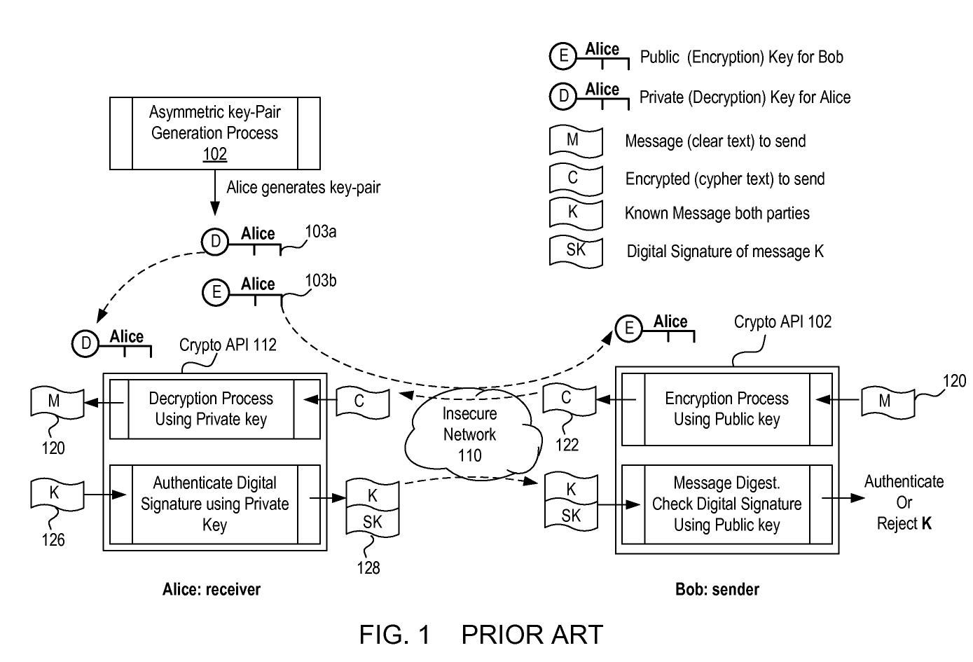

### DETAILED DESCRIPTION OF THE INVENTION

Object and/or advantage of one embodiment of the present invention is to provide an improved method and system for automatically or manually activating and deactivating software by securely delivering software license in the form of control vectors customized for a specific computing host or a registrant.

Object and/or advantage of another embodiment of the present invention is to provide a method and system for secure software licensing platform compatible with standard encryption technologies that are proven to be solid mathematically and tested over time in practice.

Object and/or advantage of another embodiment of the present invention is to provide a method and system which utilizes asymmetric cryptography (also known as public key cryptography) and digital signature technology for deploying software applications over an insecure medium of data delivery and to resist over potential alteration of data. The embodiment of the present invention offers flexibility in selecting specific cryptographic technology, as long as the encryption technology qualifies as cryptographically secure encryption based on asymmetric key pair generation.

Object and/or advantage of another embodiment of the present invention is to provide a method and system for securing secrecy of keys used for encryption by applying asymmetric cryptography, where the encryption key is kept secret by publishers, while the decryption key can be permanently destroyed to prevent leakage immediately after being included in the program source code, and assembled as part of a distribution package.

Object and/or advantage of another embodiment of the present invention is to provide a method and system for reducing the number of secrets that need to be stored or managed when an embodiment of the invention is implemented and deployed in a very large scale, such as the millions of licensees managed by each publisher.

Object and/or advantage of another embodiment of the present invention is to provide a method and system of software licensing such that software publishers and license distributors can validate if the terms of licensing are being followed by inspecting digitally signed certificates sent from the users, and enforce revocation of license and deactivation of software as needed.

Object and/or advantage of another embodiment of the present invention is to provide a method and system for providing a software licensing schema such that publishers undertake the process and responsibility for issuing licenses, while registration, accounting and subscription controls are delegated to a separate entity who would function as a license distributor.

Object and/or advantage of another embodiment of the present invention is to offer unlimited group licensing, in addition to pay-per-usage licensing. Unlimited group licensing is available when a number of software titles are available through a distributor service, then a user can activate a group of software titles by paying for collective licensing payment (such as paying for a monthly flat fee for licensing a certain number of titles). Individual publishers get paid proportionally based on quantity of license issued for titles owned by them.

Object and/or advantage of another embodiment of the present invention is to provide an improved method and system for a software licensing service where end users share the registration, credits and accounting to acquire valid licenses among multiple software publishers that are independently owned and managed.

Object and/or advantage of another embodiment of the present invention is to provide a method and system to introduce pay-per-usage model in software licensing by repeatedly issuing and delivering dynamically generated control vectors as response to the user's request, which are installed to activate or deactivate software in the authorized manner such as i) using for a valid duration, ii) permitting for a number of execution, or iii) giving access to certain features or limited functions, and the likes.

Object and/or advantage of another embodiment of the present invention is to provide a method and system to allow users to surrender unused portions of a valid license as permitted by publishers' licensing policy, so that the user can get a partial credit for that.

Object and/or advantage of another embodiment of the present invention is to achieve platform independence in the sense that the service based on the system and method of the invention can be applied across different types of target devices and mixture of delivery methods such as Internet, modem, and/or more traditional systems such as phone based license authorization.

Broadly, the present invention employs reverse asymmetric cryptography. Each application publisher uses a single universal key for all installations of deployments, which practically eliminates all burdens of key/password management tasks and software serial number tracking. Furthermore, unlike the existing approaches that failed to incorporate provisions for voluntary surrender of licenses and clear separation of roles for application publishers and distributors (or, equivalently rental service providers), the present invention makes such functionalities feasible.

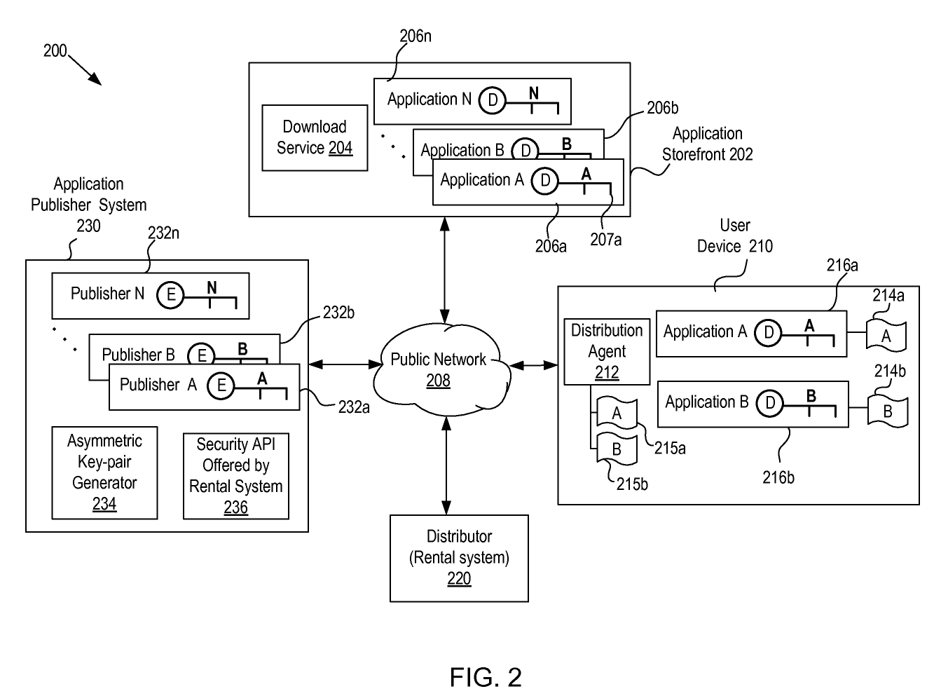

Referring now to FIG. 2, there is shown at 200 a schematic diagram of a software licensing system using asymmetric cryptography in accordance with one embodiment of the present invention. As depicted, a distribution service (or, equivalently distributor or rental system) 220, one or more user devices 210, an application storefront 202, and an application publisher system (or, shortly publisher system) 230 are connected to each other via a public network 208, such as the Internet. For brevity, only one user device 210 is shown in FIG. 2. However, it should be apparent to those of ordinary skill in the art that any suitable number of devices can be included in the system 200.

The publisher system 230, which may be a computer for serving the needs of publishers, includes one or more security APIs 236 offered by the distributor 220 and an asymmetric key-pair generator 234 for generating a key-pair, where each key pair includes an encryption key (a.k.a. public key), say 232a, and a decryption key (a.k.a. private key), say 207a. Here, the publisher refers to not only a person (or entity) who prepares the applications 206 but also a person (or entity) who gives a license for using the applications, i.e., the publisher is also a software licensor. The asymmetric key-pair generator 234 can be, but not limited to, Diffie Hellman, RSA, EIGamal, and/or elliptic curve algorithms. Then, unlike existing cryptography techniques, a publisher, say Publisher A, securely embeds the decryption key 207a into a software product, say 206a, and assembles the software product to eliminate potential leakage. Detailed description of the process for generating the software products 206 is described with reference to FIG. 4. The software product 206a might be further obfuscated to discourage any attempt in disassembling attacks.

When the publisher system 230 completes local testing, the software products 206 can be released on the application storefront 202 and distributed via a marketplace, either digitally or physically, where the software products can be priced completely based on the publisher's own policy, i.e., downloaded for free, or priced to cover packaging cost, etc.

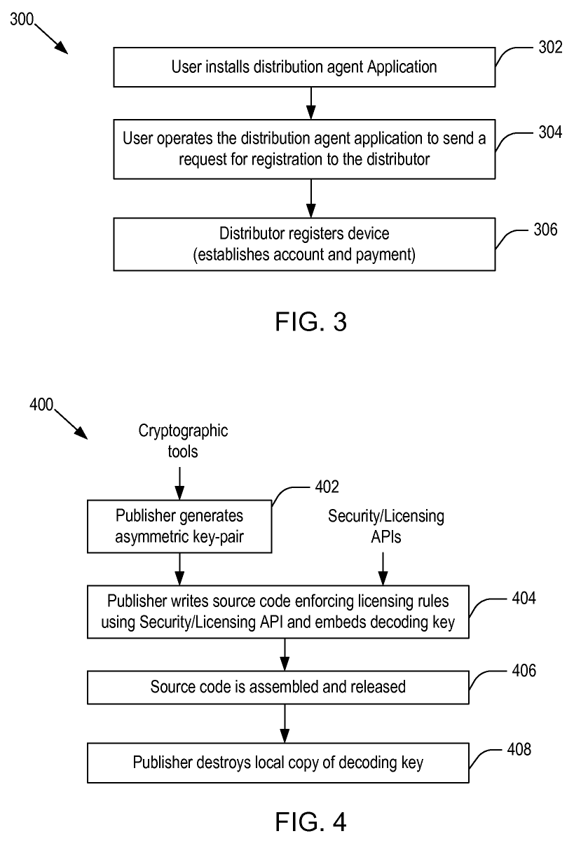

A user of the device 210, who wants to use the software product 206a, downloads a copy 216a of the software 206a via the network 208. Then, the user registers with the license distributor 220 for payment and subscription. A distribution agent application (or, equivalently, software agent or rental agent) 212, which is downloaded via the network 208 and installed in the device 210, can automate the registration process by communicating securely with the distributor (or, equivalently rental system) 220 using security measures like SSL or TLS. After the registration, the users are expected to fund their account managed by the distributor 220 by completing payment processes authorized by the distributor. Detailed description of the registration process is given in conjunction with FIG. 3.

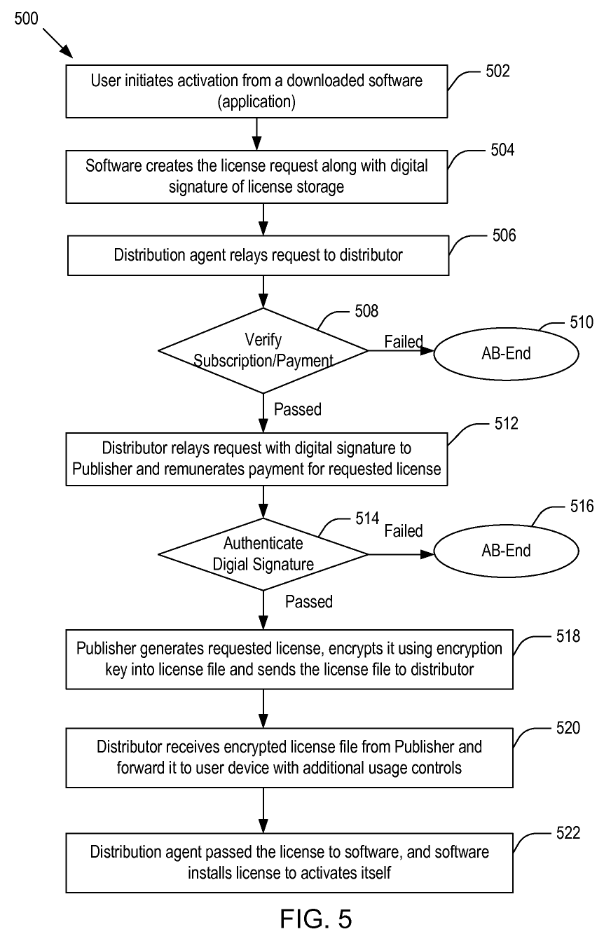

Upon completing the registration of the software product 216a in the device 210, the user transmits a request for a license key 214a for the software application 216a to the distribution agent 212. Then, the distribution agent 212 relays the request to the distributor 220, and subsequently, the distributor 220 validates the request and sends the license key 214a to the distribution agent 212. The distribution agent 212 makes a copy of the key 215a and relays the key 214a to the software product 216a to activate the software product. Hereinafter, the terms license file, license key, activation key, and control vector are used interchangeably since they contain an encryption license. Also, the terms license and rental are used interchangeably since renting a software application is getting a license under a set of present terms. Detailed description of the process for requesting the license keys 214 is given in conjunction with FIG. 5.

The software product, say 216b, securely stores locally the license file received from the distribution agent 212, and decrypts it into a control vector 214b which activates the software and authorizes the user/device 210 to use the software product as licensed. Now that the license file 214b is stored locally, the software product 214b can be activated by re-decrypting this license file into control vector as needed, until the license expires or license violation is detected. When the license expires, the user of the device 210 may request a new license or lock-out of the software product 214b.

It is noted that, unlike the existing cryptography techniques, the encryption keys 232 are kept as the publishers' secret, i.e., the cryptography technique in FIG. 2 employs reverse asymmetric cryptography. Stated differently, the present embodiment depicted in FIG. 2 reverses the process in a sense that the encryption key would stay as a secret of publisher, while the decryption key will be embedded and disseminated with software products 206. Each publisher uses a single universal key for all installations of deployments, which practically eliminates all burdens of key/password management task and software serial number tracking. Furthermore, unlike the existing approaches that failed to incorporate provisions for voluntary surrender of licenses and clear separation of roles for publishers and distributors or, equivalently, rental systems), the licensing system 200 makes such functionalities feasible.

FIG. 3 shows a flow chart 300 illustrating exemplary steps that might be carried out to register the user device 210 of FIG. 2. As depicted, the user downloads and installs the distribution agent 212 in the device 210 in a state 302. Then, the user operates the distribution agent 212 to send a request for registration to the distributor 220, where the request includes information associated with the device, such as user information, payment, and hardware ID. Next, in a state 306, the renal agent 212 relays the request to the distributor 220 and the distributor registers the device 210 by establishing an account and accepting the payment.

FIG. 4 shows a flow chart 400 illustrating exemplary steps that might be carried out by the publisher system 230 in FIG. 2 to generate a software application embedded with a decryption key. In a state 402, the asymmetric key-pair generator 234 of the publisher system 230 generates an asymmetric key-pair for each individual publisher, where the asymmetric key-pair generator may use conventional cryptographic tools to generate the key pair. As discussed above, the key pair includes an encryption key and a decryption key. The sets of security APIs 236 offered by the distributor 220, offers functionalities including subscription and payment control, request for decryption of the control vector (which includes license information to be sent by the publisher system 230), extraction of target environment ID (which includes hardware specific IDs), storage management for the received license control vector, surrendering active licenses, and other features like digitally signing current license usage information among others, where the APIs 236 are customized for the target execution platform. Using the decryption key and the features offered in the APIs along with other proprietary methods of each individual publisher, the publisher system 230 writes a source code enforcing licensing rules (specified in the APIs) in a state 404. More specifically, the decryption key may be a string of characters and embedded in the source code. Then, the publisher system 230 may assemble the source code and release the assembled code (or equivalently the software product 206) on the application storefront 202. Finally, in a state 408, the publisher system 230 may destroy his local copy of the decryption key (or, equivalently, decoding key) to eliminate any distant possibility of key leakage, to thereby enhance secrecy and security of the overall software distribution process.

By including the APIs 236 into the software product, the publisher system 230 is allowed to program his application software product to implement pay-by-usage and to protect his own interest in guarding the way the program is activated and executed, and other intellectual properties embedded within their software.

As explained above, each publisher is responsible for keeping secrecy of the encryption key, and can generate encrypted licenses using the key. This encrypted license can only be decrypted using the decryption key embedded in the corresponding application software product 216, if and only if no alteration exists along the delivery path via the network 208. That means the distributor 220 could not and should not be responsible for alteration or fabrication of licensing terms set by each publisher. Any time a user sends a request to the publisher system 230 via the distributor 220, the key storage and other information the publisher wanted to validate from the deployed software product 216 will be electronically signed using the decryption key embedded in the software product 216, where the electronic signature can be implemented by the publisher system 230 using the security APIs 236. Using the non-refutability feature of such digital signature and message digesting technology, the publisher system 230 can securely confirm the status and validity of any request generated by the deployed application software product 216 (or 206).

FIG. 5 shows a flow chart 500 illustrating exemplary steps that might be carried out to activate a software product, say 216b, downloaded in the user device 210. In a state 502, the user initiates the activation process from the software product 216b. For instance, the user may push a button on the GUI displayed on the device 210 to initiate the activation process. Then, in a state 504, the software product 216b creates a request for a license 214a that can unlock the software product 216b and transmits the request to the distribution agent 212 along with information of license storage, where the information may be digitally signed using the decryption key embedded in the software product 216b and contains licensing terms and other details like hardware ID. In one embodiment, the request may be written in plain text. The license storage, called the key chain, refers to the area where the software product 216b stores the license key 214b. Then, in a state 506, the distribution agent 212 relays the request with the digital signature of the license storage information to the distributor 220. Subsequently, in a decision block 508, the distributor 220 performs authentication of the subscriber and checks payment status of the subscriber, i.e., checks the remaining balance in the account of the user of the device 210. If the answer to the decision block 508 is negative, the process terminates in a state 510. Otherwise, the process proceeds to a state 512.

In the state 512, the distributor 220 forwards the request to the publisher system 230 along with the digital signature, the payment approval and other auxiliary information of the user, device, and licensing terms. Also, the distributor 220 remunerates payment for the requested license. When the publisher system 230 receives the request, the publisher system 230 authenticates the digital signature in a decision block 514. If the authentication fails, the process terminates in a state 516. Otherwise, the publisher system 230 generates a control vector enforcing all licensing terms in a state 518. This control vector is then encrypted into a form of a license file using the encryption key 232b guarded at the publisher's safe. Then, the license file is transmitted to the distributor 220 via the network 208.

The control vector, which is customized for a registered host 210, is encrypted by the publisher system 230 using the publisher's encryption key 232b, and then delivered for authorized use of the software product 216b. Thus, the present invention allows a publisher to handle the entire cryptography process using only one pair of encryption and decryption keys—in other words, one secret per each publisher/application is needed. The publisher may use one pair of asymmetric keys for each application or for entire applications prepared by the publisher. This significantly reduces the number of asymmetric key-pairs to be manages by the distributor 220 and the publisher system 230. Also, the subscription and payment control can be safely delegated to the distributor 220 by a large number of publishers.

Next, in a state 520, the distributor 220 forwards the license file to the distribution agent 212 in the user device 210 with additional usage controls via the network 208. The usage controls include, for instance, how frequently the license key should be validated in the corresponding application; how/when the local clock should be verified against the server clock to prevent fooling around local clock; how, when, or how frequently the keys stored under the distribution agent 212 and the applications 206 should be synchronized. Then, in a state 522, the license file is relayed back to the application by the distribution agent 212 to warrant a delivery method that is secured against the man-in-the-middle attack. The software product 216b uses the license file (or license key) 214b to unlock and activate itself. The distribution agent 212 makes a copy of the license key 215b and stores in the key chain.

Optionally, the publisher system 230 may delegate the right to generate the license to the distributor 220. In such a case, the distributor 220 may perform the steps 512 to 520, i.e., the distributor 220 generates and encrypts the license file and sends it to the user device 210.

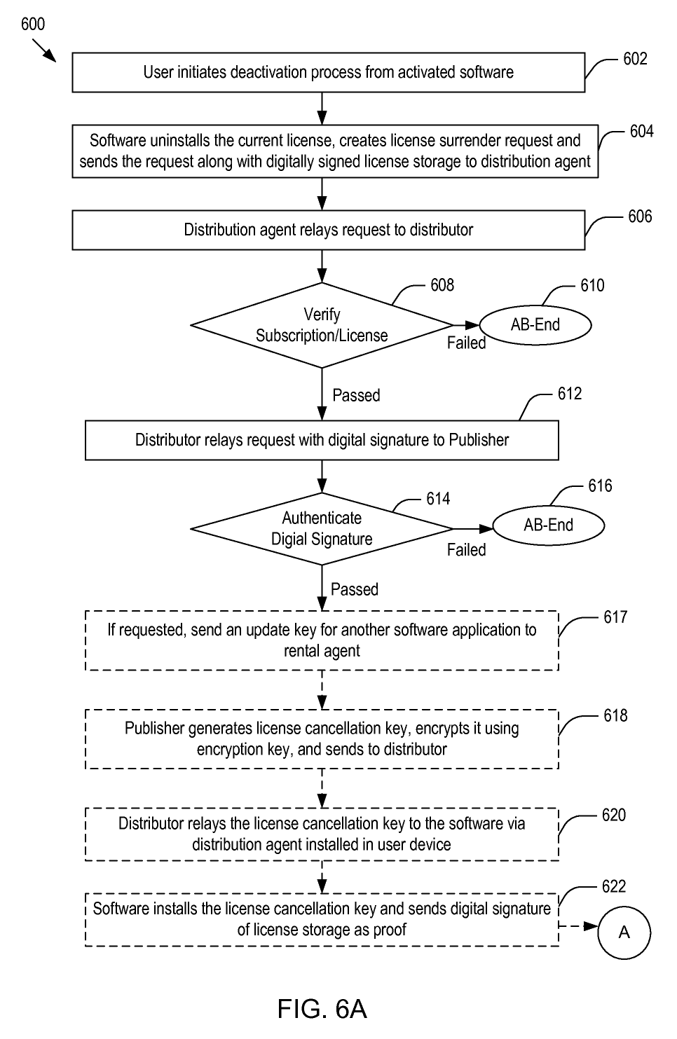

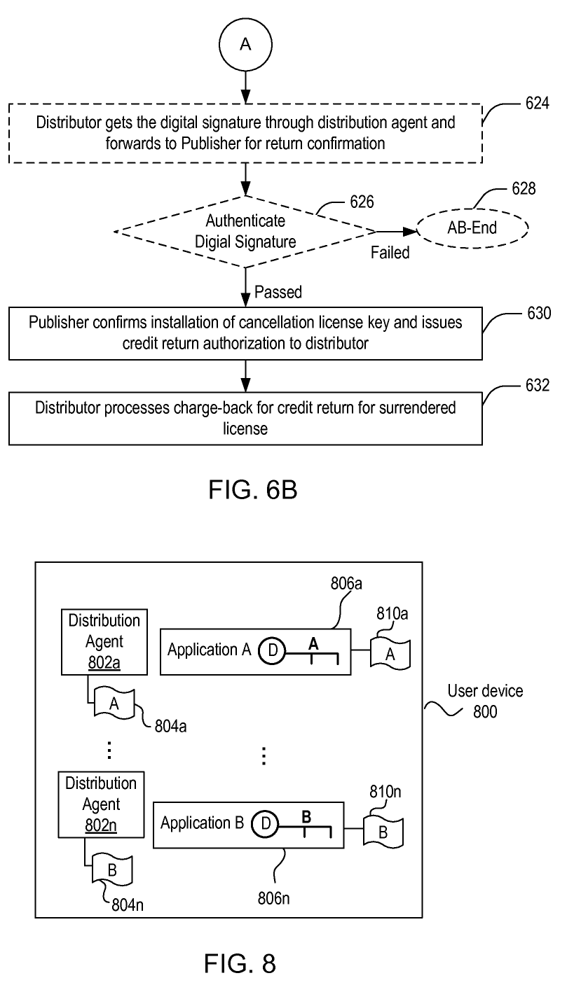

FIG. 6 shows a flow chart 600 illustrating exemplary steps that might be carried out to deactivate a software application, say 216a, in the user device 210. The deactivation process (or, equivalently license surrendering process) is very similar to the new license request process described in FIG. 5, with the difference that the deactivation process is allowed only if the publisher system 230 and distributor 220 jointly approve such process in advance. If allowed, a user initiates the deactivation process in a state 602. Then, in a state 604, the software product 216a first removes (i.e., uninstalls) the license file 214a, creates a license surrender request, digitally signs the information that proves the license storage is empty to thereby confirm the deactivation of the software product 216a, then securely transmits the request with the digital signature of the license storage to the distribution agent 212. The digital signature may be generated by use of the decryption key embedded in the software product 216a.

As an option, the user may exchange/swap the license of the deactivated (or, equivalently, surrendered) key into another license for a designated application. In such a case, the user may initiate a request for an updated key for the designated application as well as a request for the deactivation process in the state 604. Also, the request for an update key is sent to the distribution agent 212. Then, in the state 606, the distribution agent 212 relays the request to the distributor 220. Then, the process proceeds to a decision block 608.

In the decision block 608, the distributor 220 validates the request. More specifically, the distributor 220 performs authentication of the subscriber and checks payment status of the subscriber, i.e., checks the remaining balance in the account of the user of the device 210. If the validation fails, the process terminates in a state 610. Otherwise, the process proceeds to a state 612. In the state 612, the distributor relays the request with the digital signature of the license storage to the publisher system 230 for a return authorization. When the publisher system 230 receives the request and the digital signature of the license storage, the publisher system 230 authenticates the digital signature in a decision block 614. If the authentication fails, the process terminates in a state 616. Otherwise, the process may proceed to a state 630.

Optionally, as discussed above, the user may want to exchange the valid license of the removed key with an updated key for another application. In such a case, the distributor 220 may generate an updated key and send a duplicated key to the distribution agent 212 in a state 617. Since the process to generate and use the updated key is similar to the process described in FIG. 5, detailed description of the process is not repeated. Then, the process may proceed to optional states 618-630.

In the state 618, the publisher system 230 generates a control vector for license cancellation, encrypts the control vector using the encryption key 232a, and sends the encrypted control vector (or, equivalently, cancellation license, neutralizing license, license cancellation key) to the distributor 220. The cancellation license is a ‘null license’ that can positively disable the software product 216a, where the publisher system 230 encrypts it with the encryption key 232a like other license files before forwarding to the distributor 220. Then, in a state 620, the distributor 220 relays the license cancellation key to the software application 216a via the distribution agent 212. Next, in a state 622, the software product 216a installs the license cancellation key to neutralize itself, digitally signs the information of the license storage as proof of cancellation, and sends the digitally signed information to the distributor 220 and the publisher 230 via the distribution agent 212. Subsequently, in a state 624, the distributor 220 receives the digital signature of the license storage and forwards it to the publisher system 230. Then, the process proceeds to a decision block 626.

In the decision block 622, the publisher system 230 authenticates the digital signature. If the authentication fails, the process terminates in a state 628. Otherwise, the process proceeds to a state 630. In the state 630, the publisher system 230 confirms the installation of the cancellation license key and issues a credit return authorization to the distributor 220. Finally, in a state 632, the distributor 220 processes a charge-back procedure to return the credit for surrendered license to the user. The user may reactivate software product 216a anytime by requesting a valid license key, following the steps of the flow chart 500.

Also, as discussed above, the user may want to exchange the valid license of the removed key with an updated key for another application. In such a case, the credit returned to the user in the step 632 may be reduced by the amount spent to generate the updated key for another application.

Further description of rental service for the software products 216 using the keys 214 is disclosed in a copending U.S. patent application Ser. No. ______, entitled “Systems and methods for providing software rental services to devices connected to a network,” filed on Sep. 14, 2010, which is hereby incorporate herein by reference in its entirety.

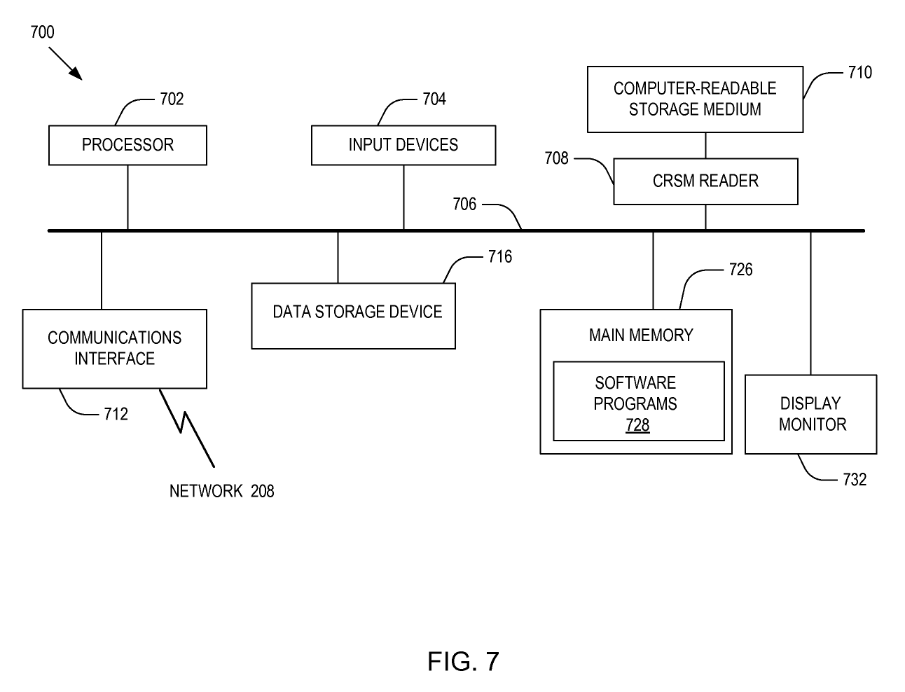

FIG. 7 is a schematic diagram of a typical computer system shown at 700 that may be employed in accordance with the present invention. Depending on its configuration, the computer system may be employed as a desktop computer, a server computer, or an appliance, for example and may have less or more components to meet the needs of a particular application. As illustrated, the computer system may include a processor 702, such as those from the Intel Corporation or Advanced Micro Devices, for example. The computer system may have one or more buses 706 coupling its various components. The computer system may also include one or more input devices 704 (e.g., keyboard, mouse), a computer-readable storage medium (CRSM) 710, a CRSM reader 708 (e.g., floppy drive, CD-ROM or DVD drive), a display monitor 732 (e.g., cathode ray tube, flat panel display), a communication interface 712 (e.g., network adapter, modem) for coupling to a network, one or more data storage devices 716 (e.g., hard disk drive, optical drive, FLASH memory), and a main memory 726 (e.g., RAM). Software programs 728, such as asymmetric key-pair generator 234 of the distributor 220, may be stored in the computer-readable storage medium 710 and read into the data storage devices 716 or main memory 726 as illustrated in FIG. 7.

The computer 700 may used to implement one or more of the distributor 220, the application storefront 202, or application publisher 230. As one of ordinary skill in the programming art can implement without undue experimentation the software programs 728, a detailed description as to the implementation of the software programs 728 is not given in the present document. It is also noted that those of ordinary skill can implement various software programs without undue experimentation that can carry out one or more steps in the processes 300, 400, 500, and 600.

While exemplary embodiments of the invention are illustrated above as shown in FIGS. 2-7, they are not to be interpreted as all or only possible use of the disclosed invention. Various simplifications and extensions can be added without limiting validity of the invention. For example, multiple keys can be used or additional symmetric keys can be communicated. In addition, publishers may employ other industry standard security features like source obfuscation or Public Key Cryptography Standard (PCKS) packaging to enhance the security of the software package they release.

It will be appreciated by those of the ordinary skill that the illustrated process may be modified in a variety of ways without departing from the spirit and scope of the present invention. For example, various portions of the processes illustrated in FIGS. 3-6 may be combined, be rearranged in an alternate sequence, be removed, and the like. In addition, it should be noted that the process may be performed in a variety of ways, such as by software executing in a general-purpose computer, by firmware and/or computer readable medium executed by a microprocessor, by dedicated hardware, and the like.

FIG. 8 shows a user device 800 in accordance with another embodiment of the present invention. As depicted, the end-user host 800 includes one or more rental agents 802a-802n having keys 804a-804n and one or more applications 806a-806n having keys 810a-810n, where each of the rental agents is associated with a corresponding application. When the user of the host 800 downloads an application, say 806a, via the network 208, the rental agent 802a implemented in the application 806a as an API program is automatically installed in the host.

Each of the rental agents 802a-802n performs the same functions as the rental agent 212 (FIG. 2), with the difference that each of the rental agents performs functions associated with only one application. For instance, the rental agent 802n plays a primary role between the application 806n and the distributor 220 as a control tower of the overall process. The major functions of the rental agent 802n includes, but is not limited to, verifying its host device 800, managing security and profiles, rental accounts, and validity, requesting the key 810n to the distributor 220, receiving the key, delivering a duplicate copy of the key 810n to the application 806n, and securing the newest key in a keychain. The rental agent 802n may keep a key 804n that is a copy of the key 810n or updated versions of the key 810n. The user of the device 800 manages its rental accounts through the rental agents 802a-802n or web browsers connected to the network 208.

It should be understood, of course, that the foregoing relates to exemplary embodiments of the invention and that modifications may be made without departing from the spirit and scope of the invention as set forth in the following claims.

What is claimed is:

1. A method for distributing a software license based on asymmetric cryptography via a network, comprising:
preparing a software application assembled with a decryption key;
receiving a request for a license key from a device via a network, wherein the device includes the software application and the license key is adapted to activate the software application; and
sending the license key encrypted using an encryption key to the device to thereby activate the software application in the device, the encryption key and the decryption key forming an asymmetric key pair.

2. A method as recited in claim 1, wherein the step of receiving a request includes:
causing the software application in the device to create the request;
causing the device to create a digital signature of a license storage associated with the license key, the digital signature being generated by use of the decryption key; and
causing the device to send the request with the digital signature via the network.

3. A method as recited in claim 2, further comprising, prior to the step of sending the license key:
determining whether the digital signature is valid; and
if the digital signature is valid, generating the license key.

4. A method as recited in claim 2, further comprising, prior to the step of sending the license key:
checking an account of a user of the device.

5. A method as recited in claim 2, wherein the device includes a distribution agent application and the step of causing the device to send the request includes:
causing the software application to send the request to the distribution agent application; and
causing the distribution agent application to relay the request with the digital signature via the network.

6. The method as recited in claim 5, further comprising, after the step of sending the license key:
causing the distribution agent application to duplicate the license key; and
causing the distribution agent application to deliver the license key to the software application.

7. A method as recited in claim 1, further comprising:
causing the software application to uninstall the license key;
causing the software application to create a license surrender request for returning the license key;
receiving the license surrender request from the device via the network; and
returning to a user of the device a credit for returning the license key.

8. A method as recited in claim 7, wherein the step of receiving the license surrender request includes:
causing the device to create a digital signature of a license storage associated with the license key, the digital signature being generated by use of the decryption key; and
causing the device to send the license surrender request with the digital signature via the network.

9. A method as recited in claim 7, further comprising, prior to the step of returning to a user of the device:
sending a license cancellation key to the device to thereby deactivate the software application.

10. A method as recited in claim 9, further comprising, prior to the step of sending the license key:
determining whether the digital signature is valid; and
if the digital signature is valid, generating the license cancellation key encrypted using the encryption key.

11. The method as recited in claim 10, further comprising, after the step of sending the license cancellation key:
causing the software application to create an additional digital signature of the license storage using the decryption key and send the additional digital signature; and
validating the additional digital signature; and
if the additional digital signature is valid, confirming deactivation of the software application.

12. The method as recited in claim 7, further comprising:
receiving, from the device, a request for an additional license key to activate an additional software application in the device; and
sending the additional license key to the device,
wherein the credit is reduced by an amount spent to generate the additional license key.

13. A method for distributing a software license based on asymmetric cryptography via a network, comprising:
generating an asymmetric key pair having an encryption key and a decryption key;
assembling a software application embedded with the decryption key;
causing a device to install the software application therein; and
sending, via the network, a license key encrypted using the encryption key to the device to thereby activate the software application.

14. A method as recited in claim 13, further comprising, after assembling the software application:
destroying the decryption key.

15. A method as recited in claim 13, further comprising, prior to the step of sending a license key:
causing the device to create the request for the license key;
causing the device to create a digital signature of a license storage associated with the license key, the digital signature being generated by use of the decryption key; and
causing the device to send the request with the digital signature via the network.

16. A method as recited in claim 15, further comprising, after the step of causing the device to send the request:
determining whether the digital signature is valid; and
if the digital signature is valid, generating the license key.

17. A method as recited in claim 15, further comprising, prior to the step of sending the license key:
checking an account of a user of the device.

18. A method as recited in claim 15, wherein the device includes a distribution agent application and the step of causing the device to send the request includes:
causing the software application to send the request and the digital signature to the distribution agent application; and
causing the distribution agent application to relay the request and the digital signature via the network.

19. The method as recited in claim 18, further comprising, after the step of sending the license key:
causing the distribution agent application to duplicate the license key; and
causing the distribution agent application to deliver the license key to the software application.

20. A method as recited in claim 13, further comprising:
causing the software application to uninstall the license key;
causing the software application to create a license surrender request for returning the license key;
receiving the license surrender request from the device via the network; and
returning to a user of the device a credit for the returning the license key.

21. A method as recited in claim 20, further comprising, prior to the step of returning to a user of the device:
sending a license cancellation key to the device to thereby deactivate the software application.

22. A method as recited in claim 21, wherein the step of receiving the license surrender request includes:
causing the device to create a digital signature of the license storage associated with the license key, the digital signature being generated using the decryption key; and
causing the device to send the license surrender request with the digital signature via the network.

23. A method as recited in claim 22, further comprising, prior to the step of sending the license key:
determining whether the digital signature is valid; and
if the digital signature is valid, generating the license cancellation key encrypted using the encryption key.

24. The method as recited in claim 20, further comprising:
receiving, from the device, a request for an additional license key to activate an additional software application in the device; and
sending the additional license key to the device,
wherein the credit is reduced by an amount spent to generate the additional license key.

25. A computer readable medium carrying one or more sequences of pattern data for distributing a software license based on asymmetric cryptography via a network, wherein execution of one or more sequences of pattern data by one or more processors causes the one or more processors to perform the steps of:
preparing a software application assembled with a decryption key;
receiving a request for a license key from a device via a network, wherein the device includes the software application and the license key is adapted to activate the software application; and
sending the license key encrypted by use of an encryption key to the device to thereby activate the software application in the device, the encryption key and the decryption key forming an asymmetric key pair.

26. A computer medium as recited in claim 25, wherein execution of one or more sequences of pattern data by one or more processors causes the one or more processors to perform the additional steps of:
causing the software application in the device to create the request;
causing the device to create a digital signature of a license storage associated with the license key, the digital signature being generated by use of the decryption key; and
causing the device to send the request with the digital signature via the network.

27. A computer medium as recited in claim 25, wherein execution of one or more sequences of pattern data by one or more processors causes the one or more processors to perform the additional steps of:
causing the software application to create a license surrender request for returning the license key;
receiving the license surrender request from the device via the network; and
returning to a user of the device a credit for returning the license key.

28. A computer readable medium carrying one or more sequences of pattern data for distributing a software license based on asymmetric cryptography via a network, wherein execution of one or more sequences of pattern data by one or more processors causes the one or more processors to perform the steps of:
generating an asymmetric key pair having an encryption key and a decryption key;
assembling a software application embedded with the decryption key;
causing a device to install the software application therein; and
sending, via the network, a license key encrypted using the encryption key to the device to thereby activate the software application.

29. A computer medium as recited in claim 28, wherein execution of one or more sequences of pattern data by one or more processors causes the one or more processors to perform the additional steps of:
causing the device to create the request for the license key;
causing the device to create a digital signature of a license storage associated with the license key, the digital signature being generated by use of the decryption key; and
causing the device to send the request with the digital signature via the network.

30. A computer medium as recited in claim 28, wherein execution of one or more sequences of pattern data by one or more processors causes the one or more processors to perform the additional steps of:
causing the software application to uninstall the license key;
causing the software application to create a license surrender request for returning the license key;
receiving the license surrender request from the device via the network; and
returning to a user of the device a credit for the returning the license key.
